(19) United States
(12) Patent Application Publication
(10) Pub. No.: US 2010/0072965 A1
(43) Pub. Date: Mar. 25, 2010

(54) OUTPUT VOLTAGE FEEDBACK DEVICE FOR BEING USED IN A POWER SUPPLYING APPARATUS AND POWER SUPPLYING APPARATUS PROVIDED WITH THE SAME

(75) Inventor: Kuan-Chun Wang, Taipei (TW)

Correspondence Address: Yen Jung Sung, 21-80 38 St, #C8, Astoria, NY, 11105, US

(73) Assignee: KERIO TECHNOLOGIES, INC., Taipei (TW)

(21) Appl. No.: 12/564,014

(22) Filed: Sep. 21, 2009

(30) Foreign Application Priority Data
Sep. 24, 2008 (TW) 97136737

(51) Int. Cl. G05F 1/10

(52) U.S. Cl. 323/282

(57) ABSTRACT

The present invention relates to an output voltage feedback device for being used in a power supplying apparatus and a power supplying apparatus provided with the same. The power supplying apparatus provides electrical power via a wire set which includes a high level wire and a low level wire. The output voltage feedback device is provided with a voltage sensor and feedback unit for determining the voltage difference between the high level wire and the low level wire and the resultant measurement is transmitted back to the converter main body via the wire set in the form of a distinct electrical signal. The output voltage feedback device according to the invention can accurately determine the output voltage from the power supplying apparatus and, in case of occurring an output fault, interrupt the supply of power or enable an automatic compensation to reduce damage.

### FIELD OF THE INVENTION

The present invention relates to a power supplying apparatus, and more particularly, to an output voltage feedback device for being used in a power supplying apparatus and a power supplying apparatus provided with the same.

### DESCRIPTION OF THE RELATED ART

Nowadays, the electronic circuits present in the major electronic devices pertain to the digital circuits that are designed to consume direct-current electricity. The electric power taken from a wall socket must be converted to have the voltages demanded by the specifications of the electronic devices before it is supplied to the electronic devices.

Further, because of the diversity of power supplies that carry out voltage conversion and provide electric power to electronic devices, each family or even each user must possess a large number of power supplies of various specifications. As portable electronic devices continue to increase in popularity and even become a part of daily life, almost all types of the major electronic devices such as portable audio/video players, mobile phones, MP3, portable game players and laptop computers are accompanied with power supplies of their own. These power supplies have their individual specifications in respect of output voltage and current and may even vary in the adapter's sizes and shapes.

Efforts have been made by manufacturers to make power supplying products suited for portable electronic devices of various specification demands. These products are made tolerable to the ordinary incoming voltage ranging from 110 volts to 220 volts and capable of selectively converting the incoming voltage into particular outgoing voltages required by the electronic devices, thereby easing the inconvenience of carrying different types of power supplies during leisure or business travel.

As shown in FIG. 1, a conventional power supply 7 is configured to operatively adjust the voltage level that is to be output to an external device by changing the resistance of a resistor mounted in a converter main body via button switches 8. However, erroneous operation of the switches 8 during a power supplying operation may undesirably result in a non-ideal voltage output and cause damage to the external device and even endanger personnel and property safety. For example, the laptop computers available in the market are normally manufactured to tolerate a 5% plus/minus variation in the ideal voltage level. In other words, damage would occur to the intrinsic circuits of the laptop computers if the incoming voltage abruptly rises, for example, from 19 volts to 24 volts and goes far beyond the tolerable range.

On the other hand, in the case where a circuit component in the converter main body is out of order by accident, the accuracy of voltage output level cannot be guaranteed even if the switches are accurately positioned. Ideally, every electronic device should be provided with an intrinsic safety circuit to prevent such over-voltage input. Unfortunately, as production cost-down becomes a dominant factor for electronic manufacturers, only simple safety circuits with minimal functions are built in electronic devices due to cost consideration, if not taken away at all.

In addition, more and more portable electronic devices, including some types of laptop computers and mobile phones and particularly the iPod® series products marketed by Apple Computer Corporation, are only equipped with built-in rechargeable batteries which cannot be removed and replaced by users. If the built-in batteries are out of order, the entire devices would have to be sent back to the companies to get checked over and repaired. To ameliorate the inconvenience caused thereby, the battery manufacturers have developed multi-functional external batteries which are suitable for being used as a backup power supplying apparatus, especially on the occasion when the built-in batteries are out of order. The universal external batteries of this type have to meet the voltage demands of various electronic devices and match in size with the charging ports of different dimensions. To meet such requirements, they are configured to offer switchable voltage output and equipped with exchangeable adapters that are normally provided in conventional power supplies and, therefore, the stability problems that happen in the power supplies as described above may come along.

As described above, conventional power supplies are normally not provided with a circuit design for monitoring the output voltage and enabling a real-time alarm in response to the occurrence of an output fault. Even if some of them are equipped with elements having monitoring functions, the manufacture cost and the sizes thereof are far beyond an acceptable level for commercially viable products. As a result, users of electronic devices still have to deal with the risk of abrupt input voltage fluctuation caused by, such as, an inadequate operation of or a structural defect in the power supplies or an unstable voltage supplying from a wall socket.

### SUMMARY OF THE INVENTION

Accordingly, an object of the present invention is to provide an output voltage feedback device, which can accurately determine the actual level of voltage output from a power supplying apparatus.

Another object of the invention is to provide an output voltage feedback device, which enables a real-time alarm and even interrupts the supply of electric power in response to the occurrence of an output fault.

It is still another object of the invention to provide an output voltage feedback device, which is suited for being used with electronic devices of various specification demands.

It is still another object of the invention to provide a power supplying apparatus, which enables double-check monitoring of the voltage output level selected by a user.

It is still another object of the invention to provide a power supplying apparatus, which is capable of maintaining the voltage output level selected by a user by using a feedback compensation mechanism.

The present invention therefore provides an output voltage feedback device for being used in a power supplying apparatus, where the power supplying apparatus comprises a converter main body including an input port, an output port and a voltage transforming unit for converting an input voltage, which is fed to the input port, into an output voltage that is to be output via the output port to power an electronic device, the output voltage feedback device comprising: a wire set for electrically connecting the output port of the converter main body to the electronic device in such a manner that the electronic device is powered by the output voltage from the output port of the converter main body, wherein the wire set includes a high level wire and a low level wire; and a voltage sensor and feedback unit for measuring a voltage difference between the high level wire and the low level wire, for converting the measured value for the voltage difference into an electrical signal that is electrically independent of the output voltage, and for feedbacking the electrical signal to the converter main body through the high level wire and/or the low level wire of the wire set.

In light of the output voltage feedback device, the invention further contemplates a power supplying apparatus for powering an electronic device, comprising: a converter main body including an input port, an output port, a voltage transforming unit for converting an input voltage, which is fed to the input port, into an output voltage that is to be output via the output port and a feedback receiving and processing unit; and an output voltage feedback device comprising: a wire set for electrically connecting the output port of the converter main body to the electronic device in such a manner that the electronic device is powered by the output voltage from the output port of the converter main body, wherein the wire set includes a high level wire and a low level wire, and a voltage sensor and feedback unit for measuring a voltage difference between the high level wire and the low level wire, for converting the measured value for the voltage difference to an electrical signal that is electrically independent of the output voltage, and for feedbacking the electrical signal to the feedback receiving and processing unit through the high level wire and/or the low level wire of the wire set.

The invention contemplates an output voltage feedback device which is configured to match with the charging ports of electronic devices to which it is to be coupled. The output voltage feedback device according to the invention enables continuous monitoring of the voltage output level from the power supplying apparatus. Then, the output voltage feedback device converts the measured value for the actual voltage output to an electronic device into an electrical signal that is distinct from the voltage output and transmits the electrical signal back to the converter main body through the same wire set used for providing electric power. This allows a processing device mounted in the converter main body to compare the electrical signal with the information corresponding to the ideal voltage selected by the user and compensate for any deviation of the actual voltage output from the ideal voltage, so that the output voltage is maintained at the ideal level.

The output voltage feedback device according to the invention may be further provided with either an alert element adapted for generating a warning signal indicating the occurrence of an output fault, or a switch that turns off to interrupt the supply of power in response to the occurrence of an output fault, thereby ensuring that damage will not occur to the electronic device as a result of the output fault. When coupled to the charging port of an electronic device, the output voltage feedback device according to the invention can accurately determine the actual level of voltage output from the power supplying apparatus, thereby ensuring a good quality of power supplying. In particular, the invention enables users to acquire an appropriate output voltage feedback device and utilize the same in conjunction with any compatible types of power supplies available in the market, so as to effectively deal with the risk of using power supplies of various specifications at low cost.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a perspective view of a conventional power supply;

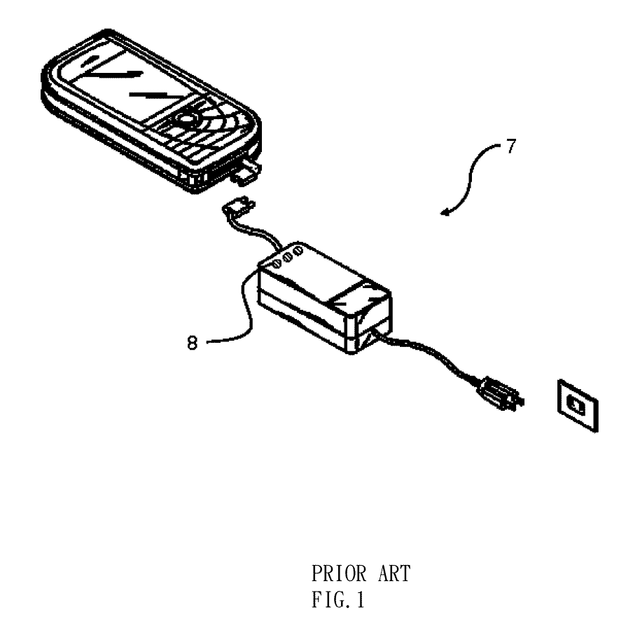

FIG. 2 is a side view of a power supply provided with an output voltage feedback device according to the first preferred embodiment of the invention, which is further connected to an electronic device;

FIG. 3 is a circuit diagram for the converter main body of the power supply according to the first embodiment of the invention;

FIG. 4 is a circuit diagram for the output voltage feedback device according to the first embodiment of the invention;

FIG. 5 is a side view of the output voltage feedback device according to the first preferred embodiment of the invention, which is additionally provided with an LED alert element;

FIG. 6 is a schematic diagram illustrating a power supply having an output voltage feedback device capable of being separated into several functional parts according to the second preferred embodiment of the invention, which is electrically connected to an electronic device;

FIG. 7 is a schematic diagram showing the way that the output voltage feedback device according to the second preferred embodiment of the invention is to be assembled and dissembled;

FIG. 8 is a circuit diagram for the output voltage feedback device according to the second preferred embodiment of the invention, which is additionally provided with a signal line;

FIG. 9 is a circuit diagram for the converter main body of the power supply according to the third embodiment of the invention, which is adapted for selecting a voltage output level in a pulse width modulation (PWM) manner; and

FIG. 10 is a schematic diagram showing the fourth preferred embodiment of the invention, in which the output voltage feedback device couples to an external battery.

### DETAILED DESCRIPTION OF THE INVENTION

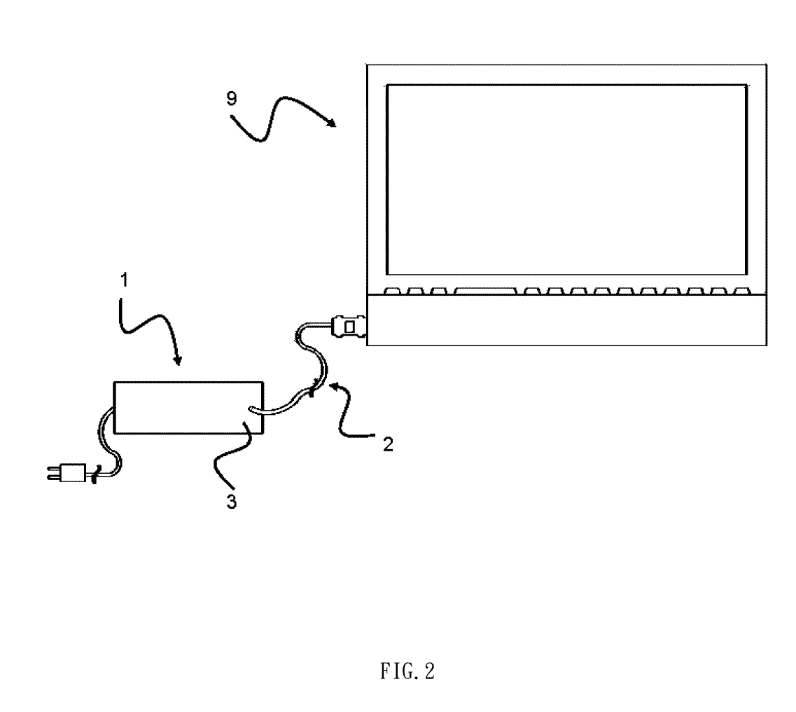

FIG. 2 is a schematic diagram illustrating the first preferred embodiment of the invention. In this embodiment, an electronic device 9 may by way of example be a laptop computer. A power supply 1 comprises a converter main body 3 and an output voltage feedback device 2, wherein the output voltage feedback device 2 has a specification compatible with that of the electronic device 9 and can be directly coupled to a charging port of the electronic device 9.

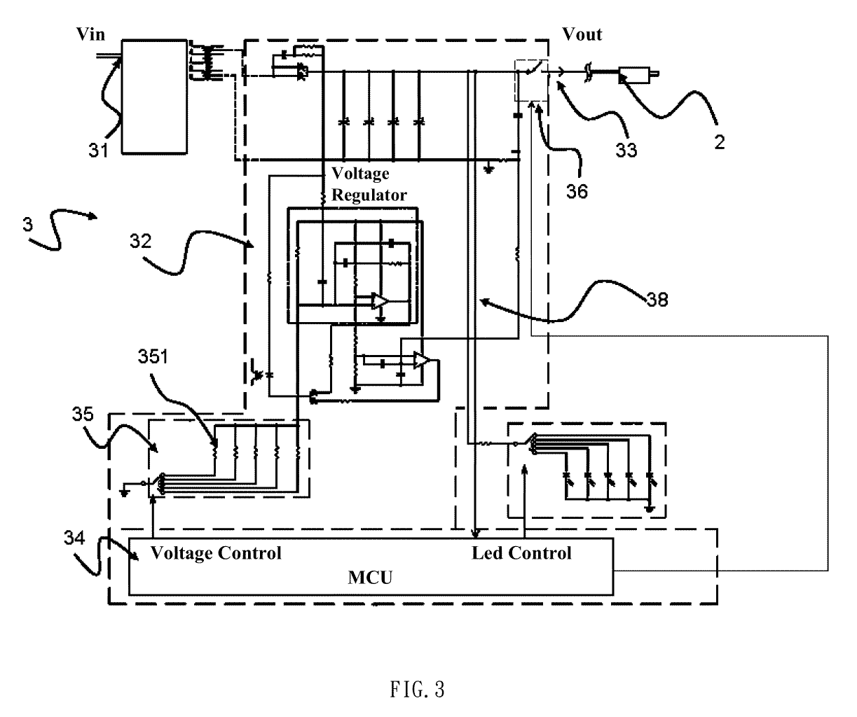

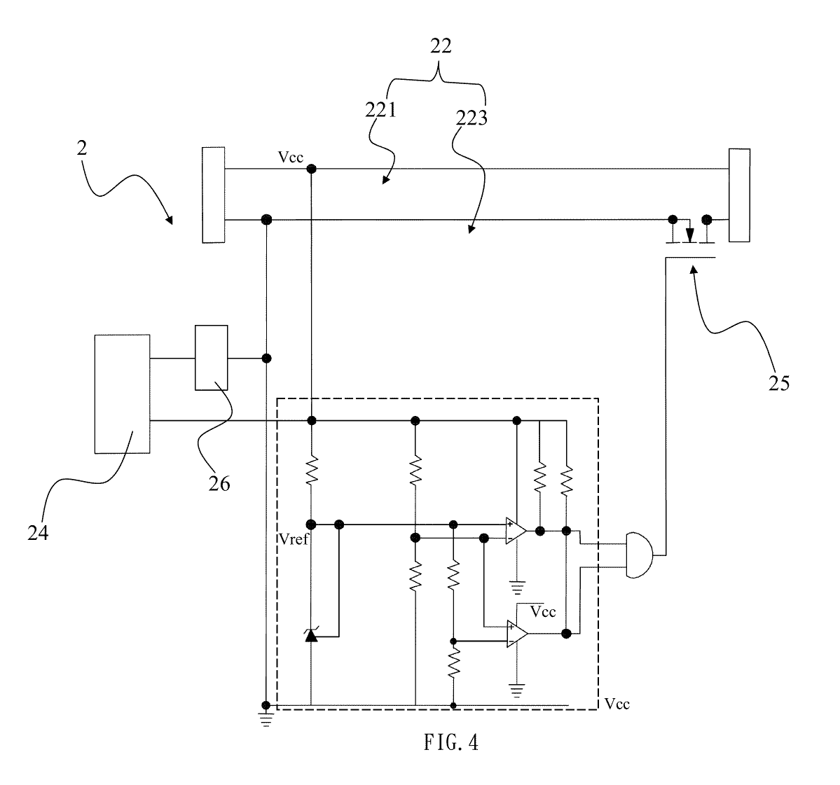

In this embodiment, as shown in FIGS. 3 and 4, the converter main body 3 comprises an input port 31 for receiving an incoming voltage, such as mains voltage; a voltage transforming unit 32 for converting the voltage fed to the input port; an output port 33 through which the converted voltage is output; and a feedback receiving and processing unit 34. For instance, the voltage transforming unit 32 receives mains power (which is in the form of alternating current) fed to the input port 31 and converts mains power, which is fed to the input port 31, into direct-current power at a desired voltage. According to this embodiment, the converting main body 3 further comprises a voltage-selecting unit 35. The voltage-selecting unit 35 includes a plurality of voltage transforming circuits 351, each being electrically connected to the output port 33. Each voltage transforming circuits 351 is provided with a circuit component with the respective circuit components being distinct from one another, so that the voltage-selecting unit 35, responsive to receipt of a command from a user, selectively places one circuit out of the voltage transforming circuits 351 in an electrical conduction state, whereby the incoming voltage is converted to the voltage selected by the user and the resultant voltage is subsequently output via the output port 33.

The output electric power passes through a wire set 22 mounted in the output voltage feedback device 2. According to this embodiment, the output voltage feedback device 2 is provided with a voltage sensor and feedback unit 24 that serves to convert the measured value for voltage to an electrical signal and transmit the electrical signal to the converter main body 3 through high and low level wires 221, 223 of the wire set 22. The electrical signal is subsequently transmitted back to the feedback receiving and processing unit 34 via an internal feedback line 38. According to this embodiment, the feedback receiving and processing unit 34 may by way of example be a microprocessor and, in this case, the feedback receiving and processing unit 34 places a built-in protective switch 36 to be in a disconnection state where circuit current is interrupted upon receiving the electrical signal, so as to avoid the power supply from providing a faulty voltage.

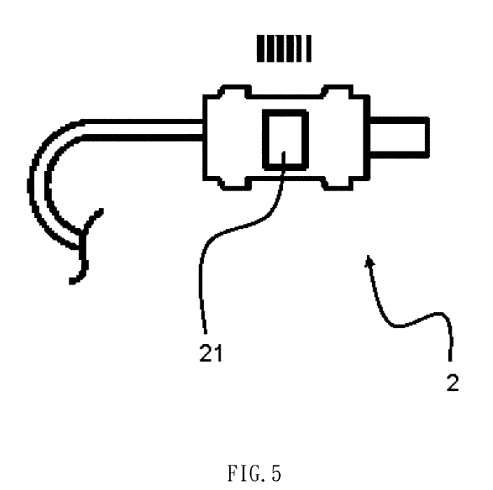

Of course, it would be appreciated by those skilled in the art that the invention is not limited to the embodiment described above, in which the voltage sensor and feedback unit 24 is provided to send information regarding the measured values for voltage back to the converter main body 3 at any moment, but also includes the embodiments shown in FIGS. 4 and 5 as described below. As shown in FIGS. 4 and 5, an output voltage feedback device 2 comprises a wire set 22, a voltage sensor and feedback unit 24 and a memory unit 26. The wire set 22 includes a high level wire 221 and low level wire 223, each being electrically connected to the output port of the converter main body 3. The memory unit 26 stores information regarding a predetermined voltage.

By virtue of such an arrangement, if the voltage difference measured by the output voltage feedback device 2 does not deviate from the voltage information stored in the memory unit 26 beyond a predetermined deviation, no signal would be feedbacked to the converter main body 3. Once the deviation reaches a threshold level, however, the voltage sensor and feedback unit 24 places a switch 25 mounted in the low level wire 223, which may by way of example be a metal-oxide-semiconductor field-effect transistor (MOSFET), to be in a disconnection state where circuit current is interrupted and sends an output fault signal to the power supply (not shown). The output voltage feedback device 2 according to the invention may be further equipped with an alert element 21, which may by way of example be a light emitting diode configured to either emit strong red light or flash to indicate the occurrence of an output fault as detected by the output voltage feedback device 2.

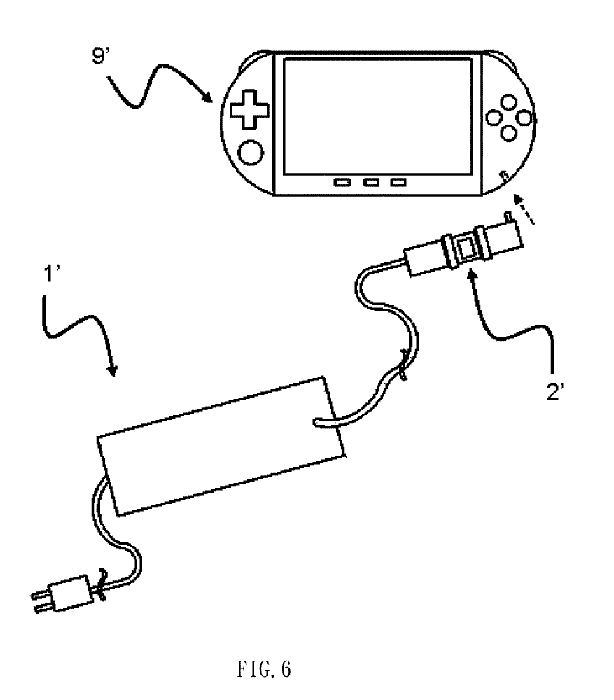

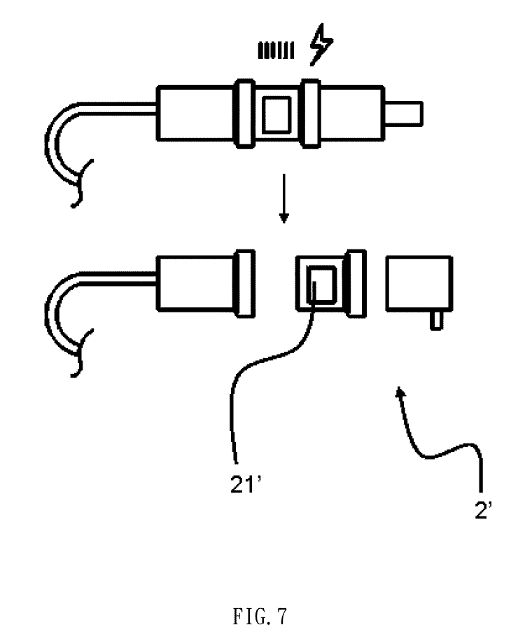

In addition, according to the second preferred embodiment of the invention shown in FIGS. 6 and 7, an output voltage feedback device 2′ is optionally manufactured to be in the form of a separable element having an exchangeable adapter for coupling to a charging port of an electronic device 9′. By this way, the output voltage feedback device 2′ according to the invention is well-suited for being used with different electronic devices 9′ which have various specifications in respect of charging ports.

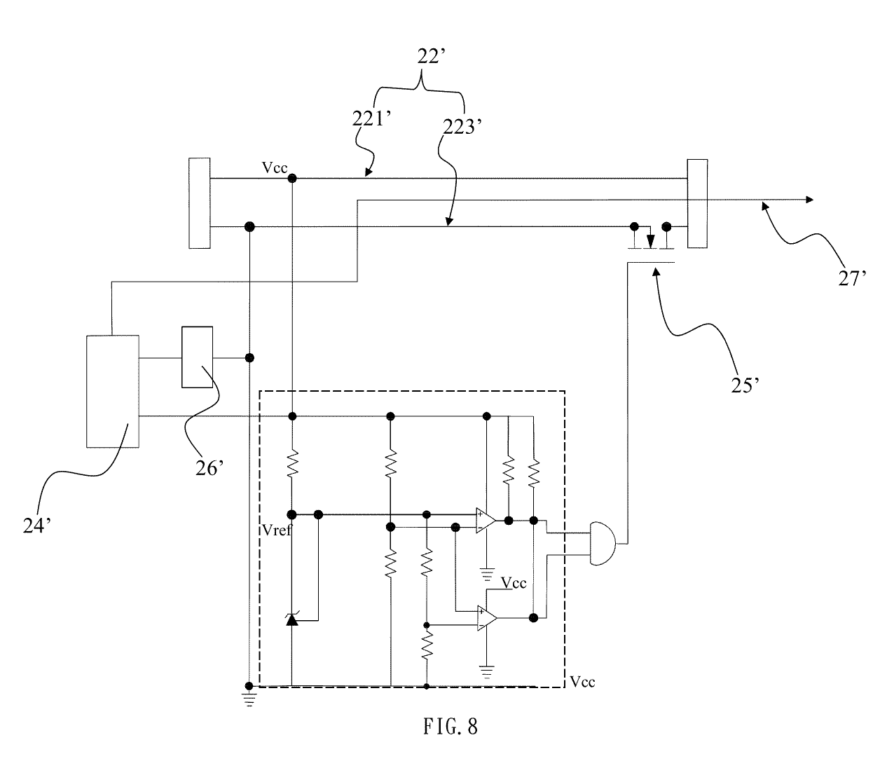

Meanwhile, in order to facilitate convenience for the users in utilizing a wide variety of electronic devices, the inventor contemplates a power supply 1′ which is provided with an alert element 21′ for generating an alarm sound in case of occurring an output fault. When the power supply 1′ is disposed at a remote location where the user cannot perceive visually, the alert element 21′ functions to warn the user in the event that the output voltage feedback device 2′ detects a non-ideal voltage. As shown in FIG. 8, in the case where the manufacturers of electronic devices install a safety switch (not shown) at the charging port of an electronic device, the invention can further improve the safety of the electronic device by measuring the voltage difference between a high level wire 221′ and a low level wire 223′ in a wire set 22′ and comparing the measured voltage difference with the voltage information stored in a memory unit 26′, followed by rendering a voltage sensor and feedback unit 24′ to generate an electrical signal indicative of a correct output when the voltage difference falls within a predetermined range, thereby driving a switch 25′ to be in a connection state where circuit current is conducted. Through a signal line 27′ that has one terminal electrically connected to the voltage sensor and feedback unit 24′ and the other terminal electrically connected to a downstream electronic device (not shown), the downstream electronic device will receive the electrical signal indicative of correct output from the power supply before starting to operate.

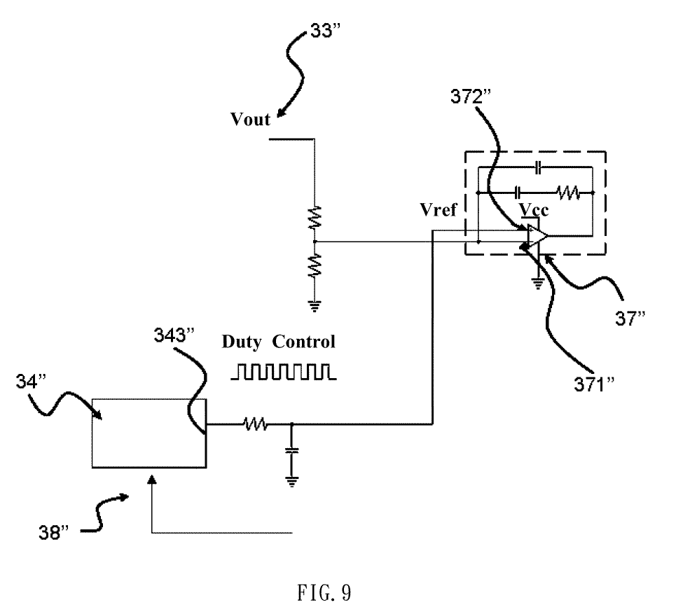

Besides the basic modes that determine whether a voltage output is correct or faulty, a sophisticated mode shown in FIG. 9 may be employed in the invention, where a feedback receiving and processing unit 34″ adjusts the duty-cycle ratio of the PWM-signal at a PWM output terminal 343″ based on the electrical signal transmitted through a feedback line 38″. The adjusted PWM-signal is then transmitted to, for example, the input terminal of an amplifier 37″ having an inverting input terminal 371″ and a non-inverting terminal 372″ to compensate the voltage deviation, whereby the output voltage at the output terminal 33″ is resumed to a predetermined level.

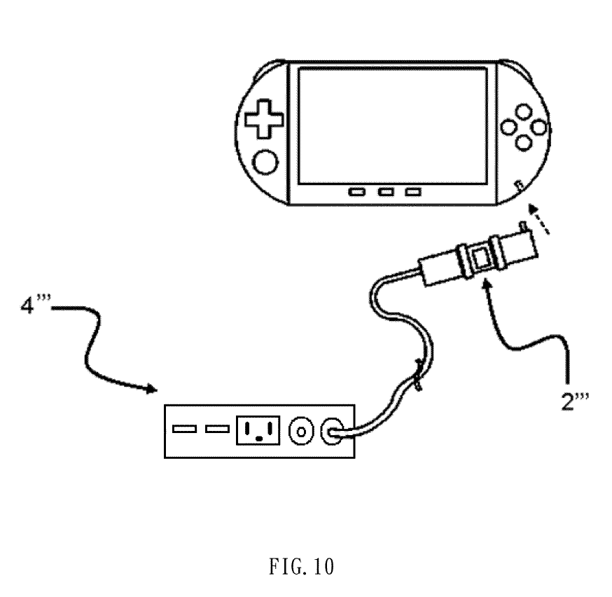

Of course, it would be appreciated by those skilled in the art that the term “power supplying apparatus” used herein is not limited to the power supply described above, but includes other means for supplying electric power, such as the external battery 4′″ shown in FIG. 10. The external battery 4′″ is cooperatively used with an output voltage feedback device 2′″ in such a manner that the adjustable voltage output from the external battery 4′″ is monitored by the output voltage feedback device 2′″. The feedback device 2′″ in turn sends the measured value for the voltage output back to the battery 4′″ through one of the high and low level wires, thereby ensuring that the output voltage is at a safety level for the electronic device to which the feedback device 2′″ couples.

As described above, the invention enables a user to ensure that the electronic device he is using is receiving a voltage at a desired level by simply acquiring an appropriate output voltage feedback device for the electronic device and directly coupling the same to the charging port of the electronic device. The output voltage feedback device according to the invention is simple in structure and can be used in conjunction with any compatible types of power supplies available in the market to effectively deal with the risk of using power supplies of various specifications.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. An output voltage feedback device for being used in a power supplying apparatus, where the power supplying apparatus comprises a converter main body including an input port, an output port and a voltage transforming unit for converting an input voltage, which is fed to the input port, into an output voltage that is to be output via the output port to power an electronic device, the output voltage feedback device comprising:
a wire set for electrically connecting the output port of the converter main body to the electronic device in such a manner that the electronic device is powered by the output voltage from the output port of the converter main body, wherein the wire set includes a high level wire and a low level wire; and
a voltage sensor and feedback unit for measuring a voltage difference between the high level wire and the low level wire, for converting the measured value for the voltage difference into an electrical signal that is electrically independent of the output voltage, and for feedbacking the electrical signal to the converter main body through the high level wire and/or the low level wire of the wire set.

2. The output voltage feedback device according to claim 1, further comprising a memory device, which is provided to store information of a predetermined range for the voltage difference so that the voltage sensor and feedback unit outputs an electrically independent electrical signal indicative of an fault of the output in the event that the voltage difference between the high level wire and the low level wire substantially deviates from the predetermined range for the voltage difference.

3. The output voltage feedback device according to claim 2, further comprising a switch, which is mounted in the wire set so that the voltage sensor and feedback unit drives the switch to be in a disconnection state where circuit current is interrupted in the event that the voltage difference between the high level wire and the low level wire substantially deviates from the predetermined range, whereby the electric power supplied to the electronic device is interrupted.

4. The output voltage feedback device according to claim 2, further comprising an alert element, which is arranged so that the voltage sensor and feedback unit drives the alert element to generate a warning signal in the event that the voltage difference between the high level wire and the low level wire substantially deviates from the predetermined range.

5. The output voltage feedback device according to claim 4, wherein the alert element comprises a light emitting diode.

6. The output voltage feedback device according to claim 1, wherein the wire set further comprises a signal line having a first terminal that is electrically connected to the voltage sensor and feedback unit and a second terminal that is adapted for transmitting the electrical signal converted from the measured value for the voltage difference between the high level wire and the low level wire to the electronic device.

7. The output voltage feedback device according to claim 1, further comprising a memory device, which is provided to store information of a predetermined range for the voltage difference so that the voltage sensor and feedback unit outputs an electrically independent electrical signal indicative of a correct output in the event that the voltage difference between the high level wire and the low level wire substantially falls within the predetermined range for the voltage difference.

8. The output voltage feedback device according to claim 7, wherein the wire set further comprises a signal line having a first terminal that is electrically connected to the voltage sensor and feedback unit and a second terminal that is adapted for transmitting the electrical signal indicative of a correct output converted from the measured value for the voltage difference between the high level wire and the low level wire to the electronic device.

9. A power supplying apparatus for powering an electronic device, comprising:
a converter main body, including:
an input port;
an output port;
a voltage transforming unit for converting an input voltage, which is fed to the input port, into an output voltage that is to be output via the output port; and
a feedback receiving and processing unit; and
an output voltage feedback device, comprising:
a wire set for electrically connecting the output port of the converter main body to the electronic device in such a manner that the electronic device is powered by the output voltage from the output port of the converter main body, wherein the wire set includes a high level wire and a low level wire; and
a voltage sensor and feedback unit for measuring a voltage difference between the high level wire and the low level wire, for converting the measured value for the voltage difference to an electrical signal that is electrically independent of the output voltage, and for feedbacking the electrical signal to the feedback receiving and processing unit through the high level wire and/or the low level wire of the wire set.

10. The power supplying apparatus according to claim 9, further comprising a memory device for storing information of a predetermined range for the voltage difference, and a switch which is mounted in the wire set so that the voltage sensor and feedback unit drives the switch to be in a disconnection state where circuit current is interrupted in the event that the voltage difference between the high level wire and the low level wire substantially deviates from the predetermined range, whereby the electric power supplied to the electronic device is interrupted.

11. The power supplying apparatus according to claim 9, further comprising a memory device for storing information of a predetermined range for the voltage difference, and a switch which is mounted in the wire set and preset in a disconnection state where circuit current is interrupted, so that the voltage sensor and feedback unit drives the switch to be in a connection state where circuit current is conducted in the event that the voltage difference between the high level wire and the low level wire substantially falls within the predetermined range.

12. The power supplying apparatus according to claim 9, wherein the converter main body further comprises a built-in protective switch electrically connected to the output port and wherein the feedback receiving and processing unit drives the built-in protective switch to be in a disconnection state where circuit current is interrupted upon receiving the electrical signal and determining that the voltage difference between the high level wire and the low level wire substantially deviates from a predetermined voltage difference beyond a predetermined deviation, whereby the electric power supplied to the electronic device is interrupted.

13. The power supplying apparatus according to claim 9, wherein the power supplying apparatus is a power supply capable of converting an input voltage into a selected output voltage out of a plurality of predetermined output voltages and outputting the selected output voltage via the output port, and wherein the converter main body further comprises an input port for receiving the input voltage.

14. The power supplying apparatus according to claim 13, wherein the voltage transforming unit further comprises a plurality of voltage transforming circuits for converting the input voltage, which is fed to the input port, into a plurality of distinct output voltages that is to be output via the output port, and wherein converter main body further comprises a voltage-selecting unit configured to selectively place one circuit out of the plurality of voltage transforming circuits in an electrical conduction state.

15. The power supplying apparatus according to claim 13, wherein the voltage transforming unit comprises an amplifier having an inverting input terminal, a non-inverting input terminal and an output terminal connected to the inverting input terminal to form a feedback loop, and wherein when the voltage difference substantially deviates from a predetermined voltage difference beyond a predetermined deviation, a pulse width modulation (PWM) output terminal provided in the feedback receiving and processing unit outputs a PWM signal to the amplifier and the PWM signal has a duty-cycle ratio adjusted based on the electrical signal to compensate for the deviation.
